(19) United States
(12) Patent Application Publication
(10) Pub. No.: US 2003/0088681 A1
(43) Pub. Date: May 8, 2003

(54) System and method for facilitating the selection of electronic services using infrared and a network address identification

(76) Inventors: Ramiro Liscano, Ottawa (CA); Victor Azondekon, Hull (CA); Michel Barbeau, Ottawa (CA)

Correspondence Address: F. Drexel Feeling, Esq., JONES, DAY, REAVIS & POGUE, North Point, 901 Lakeside Avenue, Cleveland, OH, 44114, US

(21) Appl. No.: 10/287,850

(22) Filed: Nov. 5, 2002

(30) Foreign Application Priority Data
Nov. 6, 2001 (GB) 0126649.3

(51) Int. Cl. G06F 15/16

(52) U.S. Cl. 709/229

(57) ABSTRACT

The present invention provides a system and method of communicating resource properties for facilitating the selection of electronic services using infrared and a network address identification. The method includes the steps of receiving an ID advertising message through an infrared communication port, the ID advertising message containing a network address of a mobile device and sending a service agent advertising message to the network address of the mobile device. The service agent advertising message includes a network address and properties of the resource. The method further includes the steps of receiving a service request from the mobile device and sending a service reply to the network address of the mobile device. The service reply includes information required to access the resource at an access point.

### FIELD OF THE INVENTION

The present invention relates to Ad Hoc communications and in particular to electronic service selection and association using wireless communication and network address identification.

### BACKGROUND OF THE INVENTION

A variety of mobile wireless electronic devices are available, including laptop personal computers, personal digital assistants and the like. In many instances, it is useful to connect these mobile devices to a host network for use of various services available on the host network. The facilitation of communication among nomadic or mobile device users is referred to as ad Hoc communications. For ad Hoc communication to occur, a network infrastructure must exist. The network infrastructure can be wireless, wired or a combination. By way of example, a mobile user that is a visitor to a building may wish to connect a personal computer to a host network in the building in order to use the available services. The use of service discovery methods is known to those of skill in the art in order to determine what services are available, or if a particular desired service is available.

Service discovery methods are processes in which a device continuously searches a network (or networks) to which the device is connected to determine what services are available. These services can include, for example, printers, facsimile machines, projectors, cameras, scanners, etc.

There are many existing service discovery protocols known to those of skill in the art, including JINI, Service Location Protocol (SLP), Bluetooth Service Discovery Protocol (SDP), Salutation and UPnP.

Generally, many services that are not useful or practical to a user at a given time are discovered when using conventional service discovery methods. These services may not be useful or can be impractical because they are physically inaccessible.

The available services that are discovered may be narrowed down to those that are relevant by filtering the results so that only a particular type of service is visible. For example, when a user chooses the File/Print option from the menu of an application, only devices for printing are displayed. Specifying particular features of the service desired can further narrow the visible discovered services. In the above example, for instance, a user may narrow the printers displayed to only those printers that are capable of printing in color.

When available services have been narrowed to those that are relevant, the user must then determine which services are physically accessible. There is no indication of the proximity of the user to the service and further, there is no association between the service name and the physical device. Returning to the example of the printers, there is no indication of the proximity of the user to the printer and there is no association between service name and the printer in order to aid in selection of an accessible or convenient printer.

The host network may be a fixed network or a wireless ad hoc network. A wireless ad hoc network refers to a network that is dynamically set up and torn down using dynamically created routing tables to accommodate the mobile devices that are connected and disconnected from the network. For wireless ad hoc networks, RF technology is generally employed because it passes through physical objects (it is not affected by physical objects) and due to its' broad beam transmission characteristics. While there are many advantages of the apparent transparency of physical objects to RF, this can be a problem for service discovery as all services within communication range are discovered. This can include inaccessible services such as devices located in other rooms, on other floors, or even in other buildings.

Accordingly, it is an object of an aspect of the present invention to provide a method of facilitating the selection of electronic services using infrared and a network address ID.

### SUMMARY OF THE INVENTION

In one aspect of the present invention there is provided a method of communicating properties of a resource for facilitating the selection of electronic services at the resource. The method includes the steps of receiving an ID advertising message through an infrared communication port, wherein the ID advertising message contains a network address of a mobile device, and sending a service agent advertising message to the network address of the mobile device. The service agent advertising message includes a network address and properties of the resource. The method further includes the steps of receiving a service request from the mobile device and sending a service reply to the network address of the mobile device. The service reply includes information required to access the resource at an access point.

In another aspect of the present invention there is provided a system for communicating resource properties for facilitating the selection of electronic services. The system comprises a resource having an infrared communication port. The resource is operable to receive data through the infrared communication port using an infrared communication channel. The data comprises an ID advertising message including the network address of the mobile device. The resource is connected to a network and is further operable to send a service agent advertising message to a network address of a mobile device. The service agent advertising message includes a network address and properties of the resource. The properties include electronic services provided by the resource. The resource is further operable to receive a service request from the mobile device and to send a service reply to the mobile device. The service reply includes information required to access the resource at an access point.

### BRIEF DESCRIPTION OF THE DRAWINGS

The invention will be better understood with reference to the drawings. and following description, in which:

FIG. 1 is a block diagram of a system for facilitating service selection with a network ID according to a first embodiment of the present invention;

FIG. 2A is a flow chart of a method for facilitating service selection with a network ID according to the first embodiment of the present invention;

FIG. 2B is a sequence diagram of the method for facilitating service selection with a network ID of FIG. 2A following the ODP (Open Distributed Processing) principle of viewpoints (ITU-T Recommendations X901 to X905|ISO/IEC 10746), and using UML (Unified Modeling Language—http://wvww.rational.com/uml) object-oriented methodology notation.

FIG. 3 is a block diagram of a system for facilitating service selection with a network ID according to a second embodiment of the present invention;

FIG. 4A is a flow chart of a method for facilitating service selection with a network ID according to the second embodiment of the present invention; and

FIG. 4B is a sequence diagram of the method for facilitating service selection with a network ID of FIG. 4A following the ODP principle of viewpoints and using UML object-oriented methodology notation.

### DETAILED DESCRIPTION OF PREFERRED EMBODIMENTS

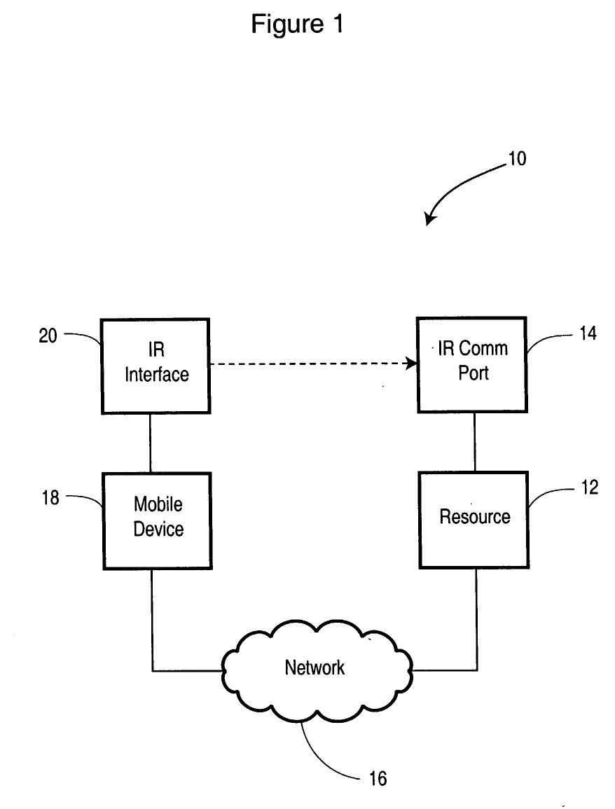

Reference is first made to FIG. 1 to describe a system for communicating a network address of an application to a resource for facilitating in the advertisement of the resource's service indicated generally by the numeral 10. In the present embodiment, system 10 has a resource 12 that includes a device that has an infrared (IR) communication port 14. The resource 12 is connected to a network 16. A portable electronic device 18, referred to as mobile device 18, is also connected to the network 16 and includes an IR interface 20. Thus the resource 12 and the mobile device 18 are interconnected through the network 16.

The mobile device 18 further includes a microprocessor, an input device, random access memory, read-only memory, a persistent storage device, and a network interface card, all of which are of conventional design and are not illustrated herein.

The resource 12 is operable to receive data through the IR communication port 14 using an infrared communication channel IRCC. Also, the mobile device 18 is operable to send data through the IR interface 20 using wide-angle IR light emitting diodes. The data is sent and received using low data rate, low cost, infrared technology, known to those of skill in the art. The resource 12 and the mobile device 18 are both further operable send and receive data through the network 16.

The mobile device 18 includes a consumer application (eg. Notetaker on a PDA) for which the use of the resource 12 is required to complete a job (eg. to print out a note).

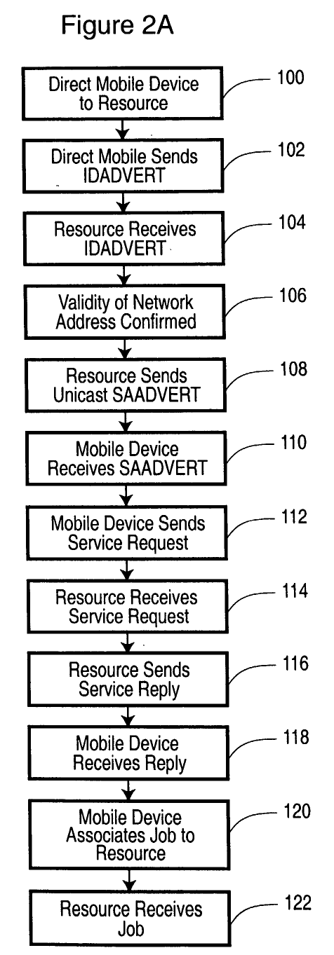

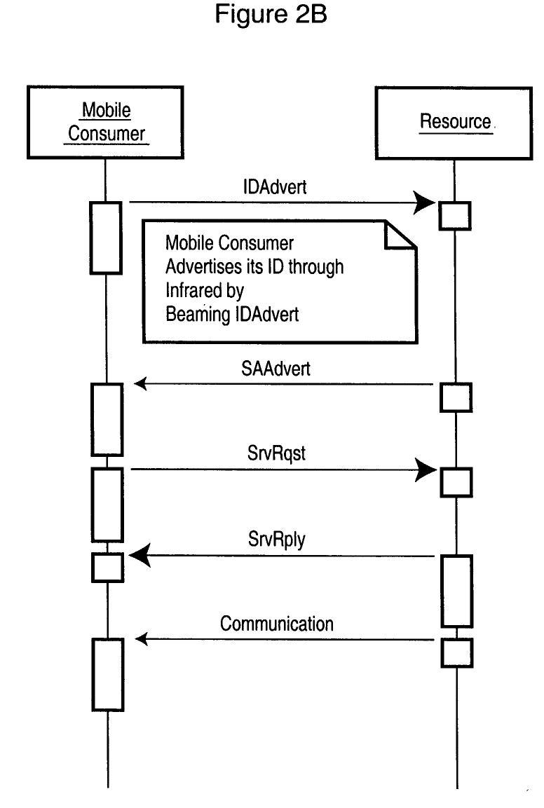

Referring now to FIGS. 2A and 2B, at step 100 the mobile device 18 is directed to the resource 12, such that the IR interface 20 points toward the IR communication port 14. Thus, the resource 12 is ready to receive data, through the IR communication port 14, from the IR interface 20 of the mobile device 18.

At step 102, an IDADVERT message is sent from the IR interface 20 of the mobile device 18. The IDADVERT message is an identifier for the mobile device 18 on the network 16. In the present embodiment, this is an IP address.

At step 104, the resource receives the IDADVERT message from the mobile device 18, through the IR communication port 14. The information from the IDADVERT message, in this case the IP address of the mobile device 18 is stored by the resource 12.

At step 106, the resource 12 confirms the validity of the IP address of the mobile device 18. The resource checks for a properly structured IP address to ensure the address contains the right number of digits in the proper range. If the IP address of the mobile device 18 is confirmed, then the resource 12 proceeds to step 108. It is to be understood that if the resource 12 is unable to confirm the IP address the resource does not proceed to step 108 and does not respond.

At step 108, the resource 12 sends a unicast service agent Advertising message (SAADVERT) to the IP address of the mobile device 18 through the network 16. The unicast SAADVERT message includes an identifier for the resource 12 on the network 16. In the present embodiment, this is an IP address for the resource 12. The unicast SAADVERT message also includes a list of attributes that include properties of the resource 12.

At step 110, the mobile device 18 receives the SAADVERT message from the resource 12, through the network 16. The mobile device 18 stores the information from the SAADVERT message, including the IP address and list of attributes of the resource 12. The mobile device 18 is operable to display the attributes of the resource 12 for a user to determine if the resource 12 has the required services.

At step 112, the mobile device 18 sends a unicast service request message (SrvRqst) to the IP address of the resource 12, through the network 16. The service request message includes a condition on the properties of the resource, as will be explained in greater detail below.

The resource 12 receives the service request message from the mobile device 18 at step 114. At this point the resource 12 determines if the services requested in the service request message are provided by the resource 12.

If it is determined at step 114 that the services requested in the service request message are provided by the resource 12, the resource replies by sending a service reply (SrvRply) to the IP address of the mobile device 12 at step 116. The service reply includes information required to access the resource (an access point), for example a uniform resource locator (URL). It will be understood that if the resource cannot provide the service, it will not respond to SrvRqst message.

At step 118, the mobile device 18 receives the service reply message which contains a URL to the access point of the resource. This is sufficient to create a connection with the resource 12.

At step 122, the job is sent from the mobile device 18, through the network 16 to the resource 12 using the access point provided in step 116.

Referring to FIG. 2B, the content of the messages of the present embodiment is summarized below. The format for this is MessageName {Value1, Value2, . . . }. The invention does not assume that it is implemented using a particular service discovery protocol like SLP or Jini, but the terminology and functionality of some of the message names conforms to those used in SLP.

IDADvert {Mobile Device Address, . . . }

Mobile Device Address—An identifier for the mobiledevice that requires a resource on the network (commonly an IP address).

This information can, for example, be stored in a structure with a variable representing the address, IDAdvert_IP_Address=123.123.123.123.

SAADvert {Resource Address, Attributes, . . . }

Resource Address—An identifier for the resource device on the network (commonly an IP address).

Attributes—A list of attributes of the resource. They express properties of the resource.

For a display resource, for example, the following exemplary properties can be listed, color=TrueColor, resolution=480×512, etc . . .

A typical SrvRqst (service request message) would include a sender address, a destination address, a service descriptor, and a set of predicates that need to be evaluated by the receiver in order to determine if it should respond to the SrvRqst message.

SrvRqst {Mobile Device Address, Resource Address, Resource Descriptor, Predicates, . . . }

Resource Descriptor—A description of the resource requested.

Predicates—A condition on the properties of a resource.

SrvRply {Mobile Device Address, Resource Address, Resource Access Point, . . . }

Resource Access Point—Information required to access the resource (In SLP it is a URL, in Jini it is an object).

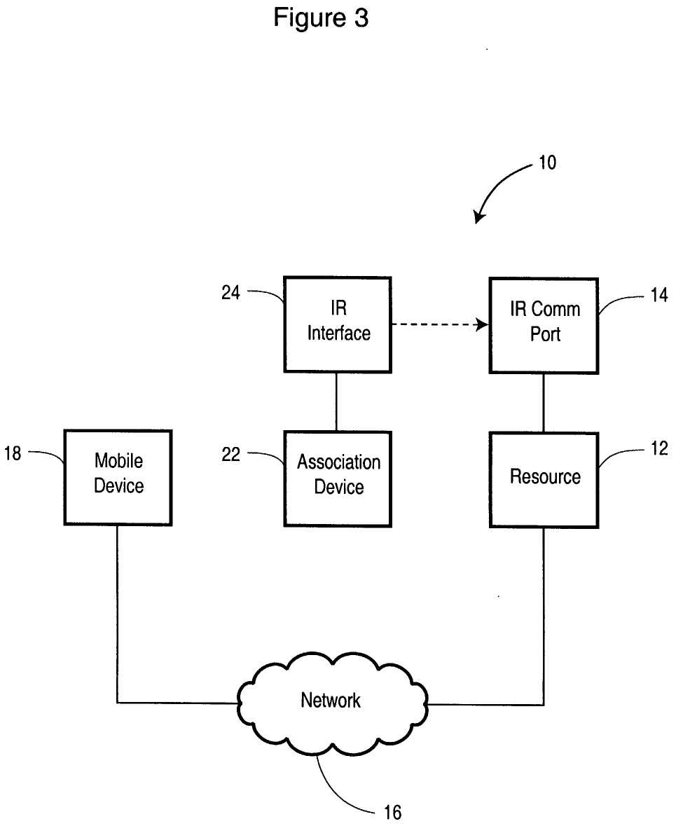

Reference is now made to FIG. 3 to describe a second embodiment of the present invention, in which the device in which the consumer application resides and the device used for association with the resource are separate of each other. For the purpose of simplicity of description, numerals used previously in the first described embodiment will be used again where the parts and steps correspond to those already described.

System 10 has a resource 12 that includes a device that has an infrared (IR) communication port 14. The resource is connected to network 16 as in the first embodiment. A mobile device 18, is connected to the network 16 by physical or by wireless connection. In the present embodiment, the mobile device 18 does not include an IR interface for establishing a connection with the resource 12, as in the first embodiment. Thus, an association device 22 that includes a bi-directional IR interface 24 is used to establish the connection.

The resource 12 is operable to receive data through the IR communication port 14 using an infrared communication channel IRCC. Conversely, the association device 22 is operable to send data through the IR interface 24 using wide-angle IR light emitting diodes. Thus, the association device 22 includes an IR association protocol for sending data. The data is sent using low data rate, low cost, infrared technology, known to those of skill in the art. Also, the resource 12 and the mobile device 18 are operable to each send and receive data through the network 16.

In the present embodiment, the association device 22 is a PDA, however other association devices can be used. For example, meme tags or Parctabs can be used to transport the IDAdvert message.

Similar to the first embodiment, the mobile device 18 includes a consumer application for which the use of the resource 12 is desired to complete a job. The association device 22 contains information including the IP address of the mobile device 18.

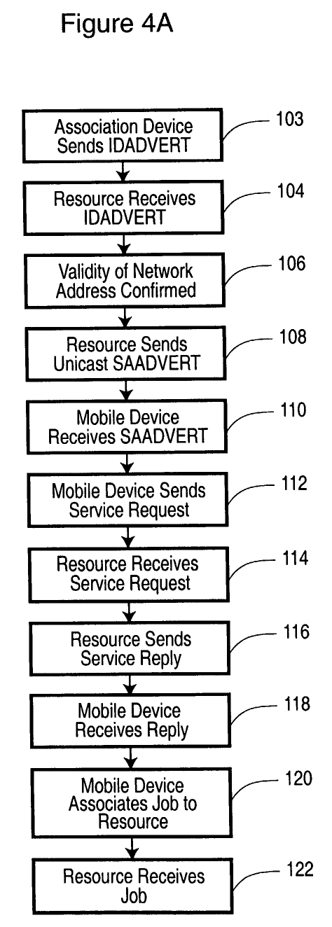

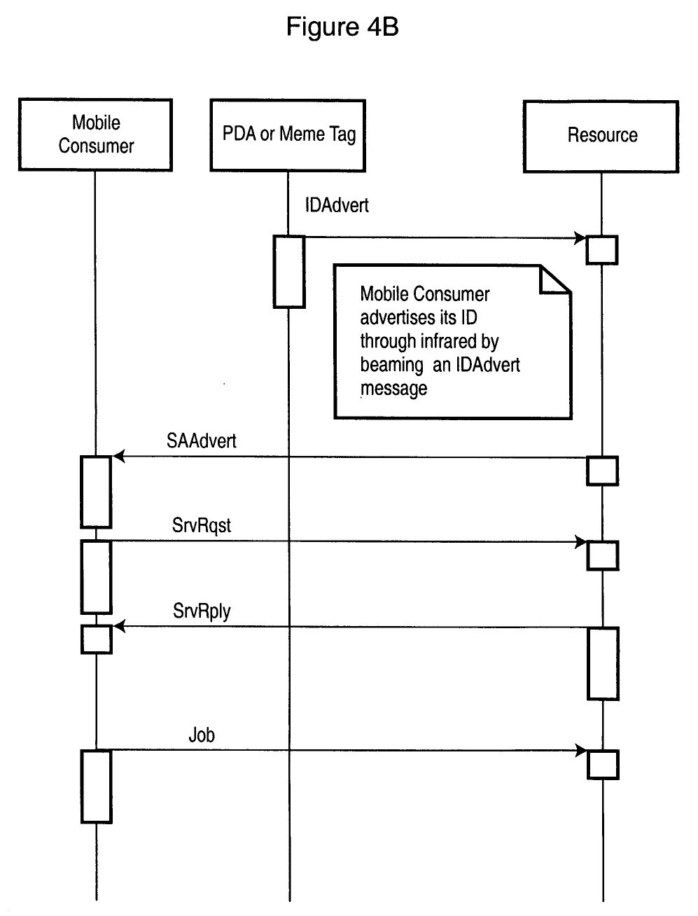

Referring now to FIGS. 4A and 4B, at step 103 the association device 22 sends an IDADVERT message from the IR interface 24. In the present embodiment, message format and content is similar to that of the first described embodiment..

It is to be understood that after step 103 is completed in which the IDADVERT message is sent to the resource 12, steps 104 to 122 of FIG. 4A are similar to steps 104 to 122 of FIG. 2A. Thus, steps 104 to 122 will not be further described herein.

It is contemplated that the present invention can be applied to any system where it is necessary to associate an application to a particular resource. For example, the present invention can be used in the discovery of telephone sets in an office space or meeting room so that a user can forward incoming calls to a particular phone set. To forward the calls, the phone set identification must be determined. The telephone set must have an infrared transmitter/receiver and must be available to communicate over a network. The network can be established in an ad hoc manner using technology such as Bluetooth if the telephone sets include the appropriate communication devices. Alternatively, the telephone sets could respond back through the telephone network.

For example, a user enters a meeting room and has a PDA that is connected to the internet via a wireless access point. From this PDA the user can communicate to their virtual personal assistant which is an application that allows them to specify rules on how to divert incoming communication requests like phone calls. It is possible to forward incoming calls to any extension line using their virtual personal assistant The user wishes to forward their incoming calls to a nearby phone in the meeting room. The user points the PDA to the telephone set to which the incoming calls will be forwarded and sends the IDADVERT message as shown in steps 100 and 102 of FIG. 2. The telephone set can advertise its' “telephone service” to the PDA and the PDA can request the service interface using a service request. The service reply then returns the location address information of the telephone, which can then be used by the PDA to tell the virtual personal assistance where to forward the user's calls.

While the embodiments discussed herein are directed to particular implementations of the present invention, it will be apparent that variations and modifications to these embodiments are within the scope of the invention as defined solely by the claims appended hereto. For example, the mobile device 18 can be a personal digital assistant, a laptop personal computer or other portable electronic device, as would occur to one of skill in the art. Also, the services can include, for example, printers, facsimile machines, projectors, cameras, scanners and the like. Also, rather than a PDA, a meme tag, a smart card or a remote control unit can be used as the association device. The association device can be any device that supports one way IR communication and is operable to enter the mobile device address. All such variations and modifications will be understood by a person of ordinary skill in the art.

We claim:

1. A method of communicating properties of a resource for facilitating the selection of electronic services at said resource, the method comprising the steps of:
receiving an ID advertising message through an infrared communication port of said resource, the ID advertising message containing a network address of a mobile device; and
sending a service agent advertising message to the network address of the mobile device, the service agent advertising message including the network address and the properties of the resource.

2. The method of communicating properties of a resource for facilitating the selection of electronic services at said resource according to claim 1, further comprising the steps of:
receiving a service request from the mobile device; and
sending a service reply to the network address of the mobile device, the service reply including information required to access the resource at an access point.

3. The method of communicating properties of a resource for facilitating the selection of electronic services at said resource according to claim 2, additionally comprising the step of:
confirming the validity of the network address using a predefined verification protocol, prior to the step of sending a service agent advertising message.

4. The method of communicating properties of a resource for facilitating the selection of electronic services at said resource according to claim 3, additionally comprising the step of
receiving a job from the mobile device, the job being received at the access point.

5. The method of communicating properties of a resource for facilitating the selection of electronic services at said resource according to claim 4 wherein the access point is a uniform resource locator (URL).

6. The method of communicating properties of a resource for facilitating the selection of electronic services at said resource according to claim 3, wherein, said ID advertising message is sent from an IR interface of the mobile device.

7. The method of communicating properties of a resource for facilitating the selection of electronic services at said resource according to claim 3, wherein, said ID advertising message is sent from an IR interface of an association device.

8. The method of communicating properties of a resource for facilitating the selection of electronic services at said resource according to claim 3, wherein, the step of receiving the service request from the mobile device includes the step of determining if the services requested in the service request message are provided by the resource.

9. The method of communicating properties of a resource for facilitating the selection of electronic services at said resource according to claim 8, wherein the resource is a telephone set.

10. The method of communicating properties of a resource for facilitating the selection of electronic services at said resource according to claim 9, wherein the mobile device is a PDA.

11. The method of communicating properties of a resource for facilitating the selection of electronic services at said resource according to claim 3, wherein the resource is a printer.

12. The method of communicating properties of a resource for facilitating the selection of electronic services at said resource according to claim 11, wherein the mobile device is a laptop computer.

13. A system for communicating resource properties for facilitating the selection of electronic services, the system comprising:
a resource having an infrared communication port, the resource being operable to receive data through the infrared communication port using an infrared communication channel, said data comprising an ID advertising message including the network address of said mobile device
the resource being connected to a network and being further operable to send a service agent advertising message to a network address of a mobile device, the service agent advertising message including a network address and properties of the resource,
said properties including electronic services provided by the resource,
the resource being further operable to receive a service request from the mobile device and to send a service reply to the mobile device, the service reply including information required to access the resource at an access point.

14. The system for communicating resource properties for facilitating the selection of electronic services according to claim 13, wherein the resource is further operable to confirm the validity of the network address of the mobile device using a predefined verification protocol.

15. The system for communicating resource properties for facilitating the selection of electronic services according to claim 14, wherein the resource is further operable to receive a job at the access point.

16. The system for communicating resource properties for facilitating the selection of electronic services according to claim 15, wherein the access point is a URL.

17. The system for communicating resource properties for facilitating the selection of electronic services according to claim 13, further comprising an association device operable to send the ID advertising message to the resource.

18. The system for communicating resource properties for facilitating the selection of electronic services according to claim 15, wherein the resource is a telephone set.

19. The system for communicating resource properties for facilitating the selection of electronic services according to claim 18, wherein the mobile device is a PDA.

20. The system for communicating resource properties for facilitating the selection of electronic services according to claim 15, wherein the resource is a printer.

21. The system for communicating resource properties for facilitating the selection of electronic services according to claim 20, wherein the mobile device is a laptop computer.
